(19) United States
(12) Patent Application Publication
(10) Pub. No.: US 2007/0048342 A1
(43) Pub. Date: Mar. 1, 2007

(54) Anti-microbial and anti-fungal additives to provide mold and mildew resistance

(76) Inventors: Robert J. Hauber, Lutz, FL (US); Mark E. Hennis, Clearwater, FL (US)

Correspondence Address: VANGELIS ECONOMOU;C/O IPHORGAN LTD, 1130 LAKE COOK ROAD, SUITE 2400, BUFALLO GROVE, IL, 60089, US

(21) Appl. No.: 11/209,375

(22) Filed: Aug. 23, 2005

(51) Int. Cl. A01N 25/00; A01N 65/00

(52) U.S. Cl. 424/405; 424/745; 424/756; 424/769

(57) ABSTRACT

A naturally derived additive to fibrous materials and to building materials for imparting resistance to mold and mildew growth, including one or more additives extracted from a group of plant species, such as those from the families of Myrtacea, Rutaceaea, Zingiberaceae and Labiatae and essential oils derived from specific species such those selected from the following groups: Melaleuca quinquenervia, Melaleuca ericifolia, Melaleuca altemifolia, Melaleuca leucadendron, Citrus reticulata and Origanum vulgare.

### BACKGROUND OF THE INVENTION

1. Field of the Invention

This invention relates generally to building materials, and more specifically to additives that can be incorporated with building materials so as to provide mold and mildew resistance thereto.

2. Background Art

Recent trends in building materials tend toward the use of inorganic component materials, at least partially to upset any fertile base that may provide for growth of mold and mildew. For example, commonly assigned U.S. Pat. No. 6,524,679 utilizes a material comprising randomly oriented inorganic fibers as an underlying facing material to avoid absorption and wicking of water or other liquids that may come into contact with the gypsum plasterboard made in accordance with the methods taught therein. This patent and the following commonly assigned patents and applications are incorporated herein by reference: patent application Ser. No. 10/968,680 filed on Oct. 19, 2004 and published under Publication No. 2005/0121131, which is a continuation in part of U.S. patent application Ser. No. 09/997,446 filed on Nov. 30, 2001, now U.S. Pat. No. 6,878,321, issued on Apr. 12, 2005, which is a division of U.S. patent application Ser. No. 09/875,733, filed Jun. 6, 2001, now U.S. Pat. No. 6,524,679.

Water repellant gypsum boards have also been used, for example, by including polymeric additives to one or more portions of a gypsum wallboard, as also taught by the above mentioned patents and applications, among others.

More recently, additives have also been provided to building materials, such as to gypsum wallboards or to joint compound. These additives are introduced so as to actively inhibit the growth of mold and mildew where the conditions for such growth are prevalent, for example, in moist or humid conditions. U.S. Pat. No. 3,998,944 to Long describes a chemical for actively inhibiting mold growth in a paper faced gypsum panel using a heavy metal salt of quinolinolate and U.S. Pat. No. 6,893,752 to Veeramasuneni, et al. describe a chemical for actively inhibiting mold growth in a gypsum panel using synthetic chemicals, such as pyrithione salts, embedded in the gypsum.

Other mold and mildew growth inhibitors are known for use with joint compounds. For example, U.S. Pat. No. 6,663,979 to Deodhas et al. teaches the use of a synthetic biocide at effective concentrations as a preservative.

However, all these prior art methods and systems rely on expensive, and possibly environmentally detrimental, synthetic anti-bacterial or anti-fungal compounds, some of which have been used as insecticides or pesticides. These include pyrithione (1-hydroxypyridine-2-thione), Methylchloroisothiazolinone or Methylisothiazolinone, all being compounds which require relatively strong concentrations to provide effective amounts for significantly inhibiting the growth of a wide variety of mold and mildew species over prolonged periods. Synthetic pesticide compounds, as have been taught in the prior art, potentially can pose health risks associated with their use, especially for those individuals who may be susceptible to even minute concentrations, in whom such minute concentrations may trigger physiological responses. Additionally, with modern insulation methods that result in tighter sealing of newer construction, even minute levels of any chemical permeating an indoor environment may become more concentrated through time as the indoor environment recirculates the air.

What is considered necessary is a compound or group of compounds that is effective in very low concentrations to inhibit growth of a large variety of mold and mildew species, which compounds are naturally produced, are a renewable resource and can be provided for easy incorporation into building materials or coated onto fibrous materials, and which compounds can retain their anti-bacterial and anti-fungal characteristics over long periods of time. The reduction of concentration of additive chemicals, and the use of naturally derived compounds are further desired as a means of reducing the possible physiological reactions of susceptible individuals, as well as costs of the additives.

### SUMMARY OF THE INVENTION

Accordingly, what is described and claimed herein is a group of naturally and organically derived compounds extracted from oils of known plant species, which in small amounts can be effective to significantly inhibit the growth of several and a broad range of species of mold and mildew that are commonly known to grow in fibrous generally, or in building materials during and after construction. In a preferred embodiment, the compounds effective to provide anti-bacterial, anti-viral and anti-fungal characteristics are derived from oils or concentrates from several plant species taken from the families of Myrtacea, Rutacea, Zingiberaceae and Labiatea. It has been found that the essential oils derived from the genus Melaleuca, and especially Melaleuca quinquenervia, possess potent mold and mildew growth inhibitors and specifically the compounds derived therefrom that include several terpenes and linalol, as described in greater detail below.

It has further been found that use of the inventive anti-bacterial, anti-viral and anti-fungal compounds and compound combinations found in the oils can be most effectively used in conjunction with the targeting of these compounds for incorporation in surface layers of glass fiber reinforced gypsum (“GRG”) boards, such as that described in aforementioned commonly assigned and invented U.S. Pat. Nos. 6,524,679, and 6,878,321, and in U.S. Published Patent Application Nos. 2005/0159057 and 2005/0121131.

Accordingly, what is described and claimed herein is a method for introducing into fibrous or building materials and fibrous or building materials for use in buildings additives that promote resistance to growth of mold and mildew by application of the additive compositions in effective amounts to control viral, bacterial and fungal growth, the additive comprising one or more naturally derived essential oils selected from the group consisting of the plant families of Myrtacea, Rutaceaea, Zingiberaceae and Labiatae. More specifically, the essential oils are preferably naturally derived from the group consisting of the plant species of Melaleuca quinquenervia, Melaleuca ericifolia, Melaleuca leucadendron, Melaleuca altemifolia, Citrus reticulata and Origanum vulgare.

### BRIEF DESCRIPTION OF THE DRAWING FIGURES

The invention described and claimed herein is more readily understood in light of the detailed description below when viewed in relation to the drawing figures, in which:

FIG. 1 is a cross-sectional view of a multi-layer gypsum board at least one of the surface layers thereof including one or more inventive anti-bacterial and anti-fungal compounds according to the present invention;

FIG. 2 is a cross-sectional view of a multi-layer gypsum board according to a second alternative embodiment of an anti-bacterial and anti-fungal gypsum board according to the present invention.

FIG. 3 is a detail view of a representative portion of a fibrous material containing or being coated by an anti-bacterial and anti-fungal composition according to the present invention.

### DETAILED DESCRIPTION OF THE PREFERRED EMBODIMENTS

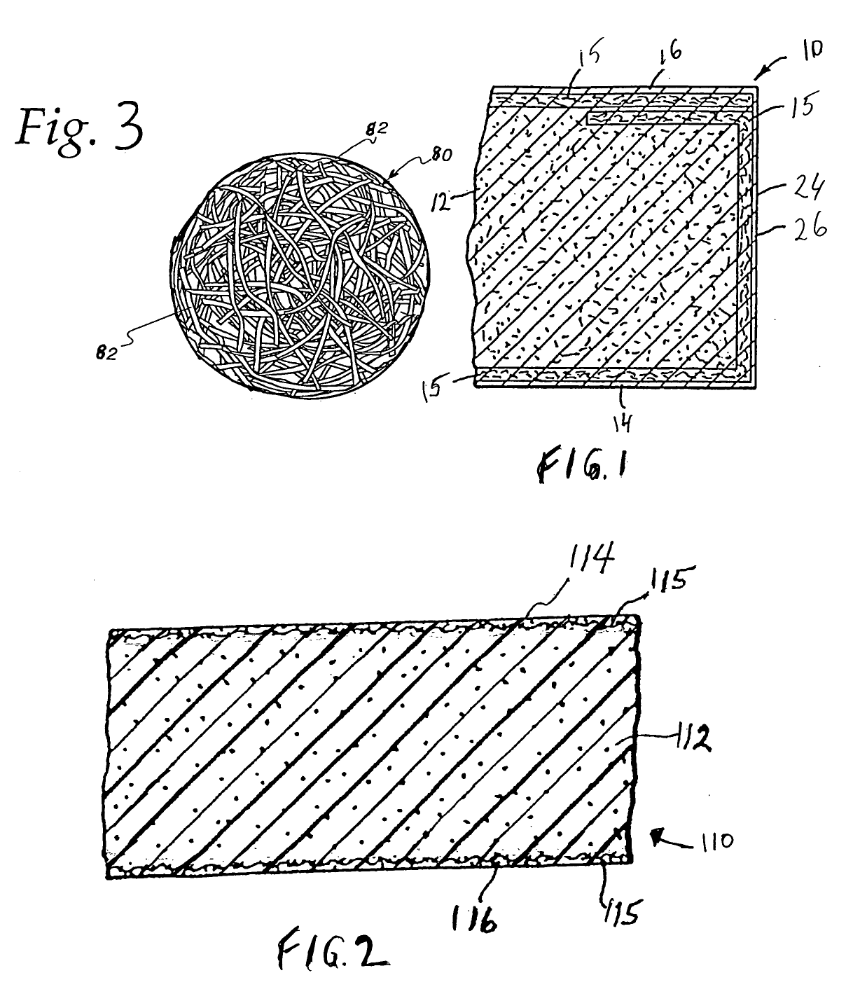

The compounds that have been found to inhibit bacterial, viral and/or fungal growth are discussed in greater detail below, and alternative preferred structures of two gypsum boards 10,110 are shown in FIGS. 1 and 2. These boards 10 and 110 incorporate the inventive compounds in one or more layers of gypsum, or are targeted to layers of gypsum disposed at the front and back surfaces of the board. The methods and manufacturing equipment used in production of gypsum boards utilizing the inventive compounds may be any of the known types. The preferred methods and equipment utilized in production of the GRG, as taught by aforementioned U.S. Pat. Nos. 6,878,321 and 6,524,679, respectively, are preferred to inhibit delamination and provide water repellant properties, as well as anti-microbial and anti-fungal properties in the boards.

While the desired properties are described below with reference to the preferred GRG board construction illustrated in FIG. 1, the compounds can in fact be utilized with any of a broad range of building materials, including without limitation paper faced gypsum board panels, gypsum board joint compounds, concrete boards, cement boards, fibrous gypsum and panels, underlayment, sheathing board, moisture resistant board, type-X board, insulation board, shaft liner, soffit board, backing board, core board, ceiling board, gypsum glass mat board, including GRG, and even may be applied onto plywood or paper-covered wallboard, integrated structures, tape for use in covering wallboard joints and in or on other building materials. Also, while advantageously used with GRG and incorporated into the dense slurry layers at the surfaces thereof, the inventive compounds can be effective when dispensed throughout the gypsum board structure, that is, including in the core gypsum layer or in boards having single layer constructions, as show in FIG. 2. Of course, the targeting of the inventive compounds to the surface layers may be preferred from considerations of production costs by concentrating the effective compounds in the surface layers, where the growth of mold and mildew may be most readily expected.

Referring now to FIG. 1, a multi-layer board 10 made in accordance with the method taught by U.S. Pat. Nos. 6,878,321 and 6,524,679, includes a central core layer 12 and two surface layers 14, 16. Each of the surface layers 14, 16 includes a structural facing sheet, generally comprising paper in the case of a single layer gypsum board described below, or a mat or sheet of randomly oriented inorganic fibers 15, as shown in FIG. 1. The mat fibers necessarily are not shown to scale and their disposition within the board 10 is not an integral part of the present invention. For a more detailed discussion of the different known board constructions, reference is made to, for example, aforementioned U.S. Pat. No. 6,878,321. The preferred embodiment may include the other improvements described in one or more of the commonly assigned patents and patent application that are referenced above.

As shown in FIG. 1, the fiber mat 15 also has been folded over to provide a machine edge 24 of the board 10, and a surface layer of dense gypsum 26 is disposed thereon, in which dense gypsum layer are entrained the anti-microbial, anti-fungal compounds according to the present invention.

In a second alternative board construction, in which a single gypsum layer board 110 is shown in FIG. 2, the facing material is again an inorganic fiber mesh, but instead of a multilayer construction, a single core layer 112 of gypsum is faced with two separated inorganic fiber mesh mats 115 disposed at both the front and back surfaces 114,116, respectively. In this type of construction, the gypsum layer 112 is of a single layer construction and may include one or more additives, such as those identified in U.S. Pat. No. 6,524,679, or others, for example, polyvinyl alcohol or polyvinyl acetate, disposed throughout the gypsum layer up to the surfaces 114,116. Although this alternative embodiment of a gypsum board panel 110 introduces the necessary additive materials, including the anti-bacterial/anti-fungal additive compositions of the present invention, the inventors hereof have noted, for example, in the aforementioned commonly assigned published patent application U.S. Patent Publication No. 2005/0121131, that targeting specific additives to a specified layer provides the dual benefit of maintaining the additives only where needed, and simultaneously omit them from areas of the building materials from where they are not required.

In the context of the inventive anti-bacterial, anti-fungal additives described and claimed herein, it is considered necessary to direct the additive only to the dense gypsum layers at the surfaces, including the dense slurry layer 24 at the machine edge surface 24 (FIG. 1) of a gypsum board 10. It is recognized that the surfaces 14,16,24, are most likely to come into contact with moisture or standing water, one of which is a prerequisite for mold and mildew growth. Thus, directing the anti-microbial/anti-fungal additive to the surface layers is most preferred. The cost savings of providing the additives only to those layers where they are needed are described more fully in aforementioned U.S. Patent Publication No. 2005/0121131, and reference is directed thereto for a fuller discussion of these benefits.

Referring now to FIG. 3, a magnified view of a fibrous material swatch 80 is shown, wherein the individual fibers 82 have been coated with an additive composition according to the present invention, such that the anti-bacterial, anti-viral and anti-fungal composition according to the present invention covers the surface of the individual fibers. Alternatively, a coating composition in which the naturally derived essential oils, or derivatives thereof, are entrained is coated onto a fibrous material that can be utilized for any use. For example, the composition of the present invention may be introduced into a batch of paper or cloth fibers used in the production of any of a number of materials, for example, paper sheets, cloth, metal fibers, etc., to which fibers it is necessary to impart desirable characteristics of resistance to mold and mildew. While these materials have not been specifically tested for resistance to the mold and mildew resistance, it is highly likely that the inventive compounds when applied to other types of fibrous materials also would impart those characteristics to other products than just those building products that were tested. Additionally, the inventive essential oils may also be added to other compositions that may be used in building materials, e.g., paints or other coatings or coverings, that can be expected to be exposed to conditions leading to mold or mildew growth. These may include, for example and without limitation, grout, tile coatings, paint and other finish coatings for building surfaces, and wax or other emulsions that can be used to coat walls, ceilings, floor surfaces, etc.

The efficacy of utilizing the inventive additives described above has been established by testing. A broad range of compositions were tested to establish the ability of specific examples of essential oils for providing effectively active ingredients for resistance to growth of mold and mildew, with the results being tabulated below in an easily readable format. For each of the examples below, the same procedure for production of a specified board, to include the active additive oils in a predetermined minute proportion, has been followed.

The tested boards were made essentially in the manner described in aforementioned U.S. Pat. Nos. 6,524,679 and 6,878,321, with minor modifications that were mostly unrelated to the present invention. One difference to the production method was to introduce an additive to the gypsum slurry mixture at the time of the board forming operation. Ideally, and as was done in the present testing regime, the anti-microbial/anti-fungal additive was added only to the gypsum slurry that formed the dense slurry layers of the board, as discussed above. The anti-microbial/anti-fungal additive was added in the form of an essential oil to the dense slurry destined for the surface layers 14,16,24 of the boards 10 of two different concentrations, one at about 0.11 weight percent and the other at 0.055 weight percent, relative to the total weight of the gypsum and water of the dense slurry layer. It was mixed thoroughly into the dense gypsum slurry, which was then impregnated into the interstices of the mat 15 and then joined to the core slurry layer 12, as described in aforementioned U.S. Pat. No. 6,524,679. The boards were then formed to their final shape, dried and cut in the conventional manner described, and tested for a four week period to determine the effectiveness of various essential oils to prevent growth of mold and mildew.

The testing procedure was essentially identical for all of the boards, each board tested (except for the control) having one of the essential oil as an additive in the dense slurry layers prior to the forming of the board, as described above. Final board production steps, such as cutting and drying having been completed, the boards were first cut into usually 3″×3″ samples, marked and tested blind, that is, the testing team were unaware which of the boards had which of the non-microbial/non-fungal additives, and indeed, did not know if any of the boards even had additives present.

The board samples were each preconditioned by storing them for four days under controlled conditions, at normal room temperature of 73.5°±3.5° and at a relative humidity of about 50%.

The board samples were then vertically suspended a little distance above a culture medium comprising previously sterilized soil containing 25% peat moss, the soil pH value being regulated at approximately 6.8. The soil was inoculated with a culture medium containing several species of mold and mildew active spores, including Aurobasidium pullulans, Aspergillus niger and Pencillium, in the enclosed test chamber. The test chamber included a recirculating air feed and conditions were maintained constant for the full four week (28 day) period, except during the times when weekly mold measurements were made of the front and back surfaces of each of the samples. Conditions in the test chamber for the testing period were maintained at a constant temperature of 90°±2° F., and at 97% relative humidity, for a four week period of testing. One or more control samples of either Ponderosa Pine Sapwood or gypsum board panels were also tested as control samples under the same conditions as the boards being tested, as is described below.

The testing standard followed was ASTM D 3273 for the testing procedure and ASTM D 3274 for the mold and mildew amount measurement. Testing included examination under a high powered microscope to determine the extent of mold and mildew growth on the board surfaces. The testing chamber was otherwise closed and sealed from the environment outside the chamber to maintain optimal conditions for mold and mildew growth in an environment where the mold and mildew were allowed to grow as aggressively as possible in the 28 day testing period.

Measurement of mold and mildew growth was performed under the ASTM D 3274 standard by a magnified field examination of the board front and back surfaces, to evaluate the amount of discoloration of the board surface. Visual inspection of the magnified areas of the surface and a rating of from 0-10 was assessed, based on the amount of mold and mildew growth, where 10 represented no growth, 7 represents 30% coverage, as indicated by discoloration, 5 represents 50% coverage, 3 represents 70% coverage and 0 represents total coverage of mold and mildew.

Results are tabulated below for each of the samples tested and are tabulated in no particular order. Each Example had two separate board samples tested, each at different concentrations. The results of the control samples are tabulated in Example 5.

### EXAMPLE 1

### Clove Oil (Syzygium aromaticum) at Different Concentrations

| | |
|---|---|
| Sample 1A (0.055%) | Sample 1B (0.11%) |

| Week | Front | Back | Front | Back |
|---|---|---|---|---|
| 1 | 10 | 10 | 10 | 9 |
| 2 | 9 | 9 | 9 | 7 |
| 3 | 8 | 8 | 7 | 5 |
| 4 | 6 | 6 | 5 | 3 |

### EXAMPLE 2

### Palmarosa Oil (Cymbopogon martiniii)

| | |
|---|---|
| Sample 2A (0.055%) | Sample 2B (0.11%) |

| Week | Front | Back | Front | Back |
|---|---|---|---|---|
| 1 | 9 | 9 | 9 | 10 |
| 2 | 7 | 8 | 7 | 8 |
| 3 | 5 | 6 | 5 | 6 |
| 4 | 4 | 4 | 4 | 5 |

### EXAMPLE 3

### Cinnamon Bark (Cinnamonum verum)

| | |
|---|---|
| Sample 3A (0.055%) | Sample 3B (0.11%) |

| Week | Front | Back | Front | Back |
|---|---|---|---|---|
| 1 | 8 | 8 | 9 | 9 |
| 2 | 6 | 7 | 8 | 8 |
| 3 | 5 | 6 | 7 | 8 |
| 4 | 4 | 5 | 6 | 7 |

### EXAMPLE 4

### Thymol Oil (Thymus vulgaris)

| | |
|---|---|
| Sample 4A (0.055%) | Sample 4B (0.11%) |

| Week | Front | Back | Front | Back |
|---|---|---|---|---|
| 1 | 9 | 9 | 9 | 9 |
| 2 | 8 | 8 | 8 | 8 |
| 3 | 6 | 6 | 6 | 7 |
| 4 | 4 | 5 | 4 | 7 |

### EXAMPLE 5

### Control

| | |
|---|---|
| Sample 5A (0.0%) | Sample 5B (0.0%) |

| Week | Front | Back | Front | Back |
|---|---|---|---|---|
| 1 | 9 | 10 | 9 | 9 |
| 2 | 6 | 10 | 6 | 8 |
| 3 | 4 | 8 | 4 | 7 |
| 4 | 2 | 7 | 2 | 6 |

### EXAMPLE 6

### Geranium (Pelargonium graveolens)

| | |
|---|---|
| Sample 6A (0.055%) | Sample 6B (0.11%) |

| Week | Front | Back | Front | Back |
|---|---|---|---|---|
| 1 | 9 | 9 | 9 | 9 |
| 2 | 7 | 7 | 8 | 8 |
| 3 | 5 | 5 | 5 | 6 |
| 4 | 4 | 4 | 4 | 5 |

### EXAMPLE 7

### Mandarin Oil (Citrus reticulata)

| | |
|---|---|
| Sample 7A (0.055%) | Sample 7B (0.11%) |

| Week | Front | Back | Front | Back |
|---|---|---|---|---|
| 1 | 9 | 9 | 9 | 9 |
| 2 | 9 | 9 | 8 | 8 |
| 3 | 8 | 8 | 6 | 6 |
| 4 | 7 | 7 | 4 | 4 |

### EXAMPLE 8

### Oregano Oil (Origanum vulgare)

| | |
|---|---|
| Sample 8A (0.055%) | Sample 8B (0.11%) |

| Week | Front | Back | Front | Back |
|---|---|---|---|---|
| 1 | 9 | 9 | 9 | 9 |
| 2 | 7 | 8 | 7 | 8 |
| 3 | 6 | 6 | 6 | 6 |
| 4 | 5 | 6 | 5 | 5 |

### EXAMPLE 9

### Cinnamon Leaf (Cinnamonum verum)

| | |
|---|---|
| Sample 9A (0.055%) | Sample 9B (0.11%) |

| Week | Front | Back | Front | Back |
|---|---|---|---|---|
| 1 | 9 | 9 | 9 | 10 |
| 2 | 8 | 8 | 7 | 9 |
| 3 | 7 | 7 | 5 | 7 |
| 4 | 5 | 6 | 3 | 6 |

### EXAMPLE 10

### Tea Tree Oil (Melaleuca altemifolia)

| | |
|---|---|
| Sample 10A (0.055%) | Sample 10B (0.11%) |

| Week | Front | Back | Front | Back |
|---|---|---|---|---|
| 1 | 9 | 10 | 9 | 10 |
| 2 | 8 | 9 | 8 | 9 |
| 3 | 6 | 7 | 7 | 7 |
| 4 | 5 | 6 | 6 | 6 |

### EXAMPLE 11

### Niaouli or Punk Tree Oil (Melaleuca quinquenervia)

| | |
|---|---|
| Sample 11B (0.055%) | Sample 11C (0.11%) |

| Week | Front | Back | Front | Back |
|---|---|---|---|---|
| 1 | 10 | 10 | 9 | 10 |
| 2 | 9 | 9 | 9 | 9 |
| 3 | 8 | 9 | 8 | 9 |
| 4 | 8 | 8 | 7 | 9 |

### EXAMPLE 12

### Blend of Oils of Examples 1, 6, 10, 11

| | |
|---|---|
| Sample 12A (0.055%) | Sample 12B (0.11%) |

| Week | Front | Back | Front | Back |
|---|---|---|---|---|
| 1 | 7 | 9 | 8 | 10 |
| 2 | 6 | 8 | 8 | 9 |
| 3 | 4 | 6 | 6 | 9 |
| 4 | 2 | 5 | 5 | 9 |

Several of the above naturally derived oils are shown above to be effective in controlling mold and mildew growth, at either or both concentrations tested, that is, at 0.055 weight percent and at 0.11 weight percent. Additives were injected into the dense slurry only at two concentration levels. Although only two concentrations of the specified additives were tested to determine the efficacy of the additives identified, other naturally derived additives may come to mind to a person having skill that are as efficacious or more so than the examples tested above. Additional testing may establish that a different range of concentrations may be more advantageous when balancing the different considerations, including the expense of additive, the possible environmental and physiological impact, the effect on the manufacturing process, and/or the relative ability to control the growth of mold and mildew.

Certain of the additives that have been tested to date have been shown to have a number of desirable properties, including the environmental friendliness, since they are naturally occurring compounds that are for the most part environmentally safe to most people, without producing side effects of sensitivity to the synthetically produced chemicals, especially at the minute concentrations thereof that have been utilized in the examples above. Additionally, costs of providing the desirable resistance to mold and mildew growth are reduced substantially over the known synthetic chemical additives, which require chemical production and synthesis, testing for environmental effects, and possible modifications to the manufacturing process of gypsum board panels. The decreased concentrations not only significantly reduce the costs of production, but also reduce the level at which sensitivity to the chemicals, if any, may become a concern. Another consideration that may potentially further reduce the costs of additives is the general availability of the essential oils because they are derived from naturally existing plants, some of which are at present considered to be unwanted invasive species in the U.S. In this case, derivation of the essential oils may be further encouraged by the desire to reduce populations of the invasive plant species from which the oils are derived.

Thus, additional species and essential oil additives may come to mind to those having ordinary skill in that other similar or dissimilar essential oils may prove to be advantageously used in building materials, as described above, and the examples used above are not to be considered limiting the scope of this invention, which are broadly noted as being the use of naturally occurring essential oils in or on building materials to provide resistance to mold and mildew growth thereon. The invention is to be considered as limited only by the following claims and equivalents thereof.

As described, either in conjunction with or without a polymeric additive, the inventive compounds may be introduced only in the dense slurry layers 14, 16, that are at the surface essentially sheathing a relatively less dense core gypsum layer 12.

Preferred additives to provide for the desired anti-bacterial and anti-fungal characteristics are essential oils taken from several groups of plant species, including the genus of Melaleuca, Mandarin etc. The inventive organic oils comprise several groups and ranges of individual compounds, in some cases similar to the groups of compounds found in other additives tested. A definitive conclusion has not been reached as to which of the compounds are the active ingredients which provide the desirable characteristics. However, from the data derived in testing of the anti-bacterial and anti-fungal properties of the different essential oils, it is believed that the combinations of the several compounds provide the effective activity to combat a majority of the common bacteria/fungi, with specific ones of the constituent compounds being most effective to inhibit the growth of specific mold and/or mildew species. A more definitive correlation of which specific compounds are most effective against which specific mold or mildew cultures awaits additional testing.

From an analysis of the constituent compounds in the several oils tested for bacteria/fungi growth inhibiting qualities, it is believed that several terpene compounds, and specifically monoterpenes, monoterpene alcohols, terpene oxides, limonene, linalol and 1, 8 cineol are considered to provide the most effective ingredients. No one of these compounds is considered effective to combat all mold and mildew cultures, but several or a combination of the compounds is considered effective against most common forms of mold and mildew. Moreover the concentrations of the essential oils in proportion to the gypsum slurry, as measured in parts per million (ppm), have been found to be effective in very small concentrations, as is described above with reference to exemplary formulations of additives in gypsum boards.

As can be seen from the data, the most effective of the essential oils that have been determined to be likely to inhibit growth of both bacteria and fungi has been the oil derived from the genus Melaleuca, and most effective has been found to be Melaleuca quinquenervia, also commonly known as Niaouli or the punk tree. This species is native to swampy areas in places such as Australia, and has recently become an unwanted species in Florida, where the plant is considered an invasive plant species.

While formal or definitive studies of the oil derived from this plant species to determine its makeup have not been established, literature in the field indicates that the composition of the essential oil derived from Melaleuca quinquenervia comprises the following: Sesquiterpenes; Monoterpene alcohols: linalol; Sesquiterpene alcohols: trans-nerolidol (81-82%), farnesols; Terpene oxides: 1,8 cineol.

According to a second preferred embodiment of an anti-bacterial and anti-fungal essential oil, oil of citrus trees has been found to be active in suppressing the growth of unwanted mold and mildew on building materials. The botanical family from which these oils are derived is the Rutaceae or citrus fruit family, and the literature provides as the active ingredients in the particular plant oil that has been tested, Citrus reticulate, as the following: Monoterpenes: limonene (65-94%); Monoterpene alcohols; Esters; Aldehydes; Coumarins. Also contains flavonoids, carotenoids, steroids.

A third naturally produced oil that has been found through testing to actively suppress mold and mildew growth is another member of the Melaleuca genus, Melaleuca altemifolia, sometimes referred to as the Tea Tree. Literature indicates the following composition for the essential oil from the Tea Tree: Monoterpenes (3-20%); α and β-pinene, myrcene; Sesquiterpenes; Monoterpene alcohols (45-50%): Terpene oxides.

A fourth naturally produced oil that is considered to actively suppress mold and mildew growth is another member of the Melaleuca genus, Melaleuca ericifolia, sometimes referred to as Rosalina. Literature indicates the following composition for the essential oil from Rosalina: Terpene alcohols (41-62%); linalol; α-terpeneol, Monoterpenes and Sesquiterpenes (13-35%); α-pinene; paracymene, limonene; γ-terpinene, aromandrene, viridiflorene.

Additional other additives may be suggested to a person of ordinary knowledge in the art, for example, other naturally derived oils that have not yet been tested, or perhaps even have not yet been discovered. Essential oils from these as yet unknown species may be considered equivalents of the present invention.

The invention herein has been described and illustrated with reference to the embodiments of FIGS. 1-3, but it should be understood that the anti-microbial and anti-fungal building materials feature of the invention is susceptible to modification or alteration without departing significantly from the spirit of the invention. For example, the dimensions, size and shape of the various materials may be altered to fit specific applications, including use as a dry ingredient in a joint compound mix. Similarly, the building panels may be formed in different shapes or dimensions, as described above. Accordingly, the specific embodiments illustrated and described herein are for illustrative purposes only and the invention is not limited except by the following claims.

What is claimed is:

1. A building material for use in buildings that is resistant to growth of mold and mildew by application of an additive in effective amounts to control bacterial and fungal growth, the additive comprising one or more naturally derived essential oils selected from the group consisting of the following plant families:
Myrtacea, Rutaceaea, Zingiberaceae and Labiatae.

2. A building material in accordance with claim 1, wherein the additive further comprises one or more naturally derived essential oils selected from the group consisting of the following plant species: Melaleuca quinquenervia, Melaleuca ericifolia, Melaleuca altemifolia, Melaleuca leucadendron, Citrus reticulate and Origanum vulgare.

3. A building material in accordance with claim 1, wherein the building material further comprises a joint compound.

4. A building material in accordance with claim 1, wherein the building material further comprises gypsum board.

5. A building material in accordance with claim 1, wherein the building material further comprises wall board.

6. The building material in accordance with claim 1, wherein the anti-microbial/anti-fungal additive comprises an effective amount in the range of from 0.01 to 5.00 weight percent of the total building material composition.

7. The building material in accordance with claim 6, wherein the anti-microbial/anti-fungal additive comprises an effective amount in the range of from 0.055 to 1.0 weight percent of the total building material composition.

8. The building material in accordance with claim 6, wherein the anti-microbial/anti-fungal additive comprises an effective amount that is approximately 0.11 weight percent of the total building material composition.

9. The building material in accordance with claim 2, wherein the anti-microbial/anti-fungal additive comprises an effective amount in the range of from 0.01 to 1.00 weight percent of the total building material composition.

10. A method of imparting resistance to mold and mildew growth to building materials comprising:
a) mixing a slurry material comprising water, gypsum and an anti-microbial/anti-fungal additive in an effective amount to resist growth of mold and mildew, wherein the additive is selected from the group of naturally derived oils from the following plant families:
Myrtacea, Rutaceaea, Zingiberaceae and Labiatae; and
b) utilizing the mixed slurry additive composition in a building product.

11. The method of imparting mold and mildew resistance to building materials in accordance with claim 10, wherein the anti-microbial/anti-fungal additive is an oil derived from one or more compounds selected from the group of plant species consisting of:
Melaleuca quinquenervia, Melaleuca altemifolia, Melaleuca ericifolia, Melaleuca leucadendron, Citrus reticulata and Origanum vulgare.

12. The method of imparting mold and mildew resistance to building materials in accordance with claim 10, wherein the mixed slurry additive composition is utilized by forming it into a gypsum board panel.

13. The method of imparting mold and mildew resistance to building materials in accordance with claim 10, wherein the mixed slurry additive composition “is utilized by forming it as a surface layer of a gypsum board panel.

14. The method of imparting mold and mildew resistance to building materials in accordance with claim 10, wherein the mixed slurry additive composition is utilized in a joint compound mix.

15. The method of imparting mold and mildew resistance to building materials in accordance with claim 10, wherein the mixed slurry additive composition is applied onto one of the group of building materials consisting of joint compound, joint tape, glass reinforced gypsum board, paper faced gypsum board, concrete board, underlayment, shaft liner, soffit board, backing board, core board, ceiling board and wood board.

16. A method of imparting mold and mildew growth resistance to fibrous materials comprising:
a) mixing a composition comprising an anti-microbial/anti-fungal additive in an effective amount to resist growth of mold and mildew on the fibrous material, wherein the additive is selected from the group of naturally derived oils from the following plant families:
Myrtacea, Rutaceaea, Zingiberaceae and Labiatae; and
b) applying the additive composition in a fibrous material.

17. The method of imparting mold and mildew resistance to fibrous materials in accordance with claim 16, wherein the additive composition is applied as a layer containing the additive composition over the surface of the fibrous material.

18. The method of imparting mold and mildew resistance to fibrous materials in accordance with claim 16, wherein the additive composition is applied as an additive composition to the fibrous material.

19. The method of imparting mold and mildew resistance to fibrous materials in accordance with claim 16, wherein the additive composition is applied as an additive composition to a covering material coated over the fibrous material.

20. The method of imparting mold and mildew resistance to fibrous materials in accordance with claim 19, wherein the additive composition is applied as a coating by one of the methods consisting of dip, spray or flow coating methods.

21. A composition of matter applied onto a fibrous material, the composition comprising one or more additives selected from the essential oils derived from group of plant species consisting of:
Melaleuca quinquenervia, Melaleuca aricifolia, Melaleuca altemifolia, Melaleuca leucadendron, Citrus reticulata and Origanum vulgare.
